(19) United States
(12) Patent Application Publication
(10) Pub. No.: US 2008/0036111 A1
(43) Pub. Date: Feb. 14, 2008

(54) NON-OXIDIZING THERMALLY CROSSLINKED POLYMERIC MATERIAL AND MEDICAL IMPLANT

(76) Inventor: Dehchuan Sun, Taipei City (TW)

Correspondence Address: LOWE HAUPTMAN HAM & BERNER, LLP, 1700 DIAGONAL ROAD, SUITE 300, ALEXANDRIA, VA, 22314, US

(21) Appl. No.: 11/463,423

(22) Filed: Aug. 9, 2006

(51) Int. Cl. C08F 110/02; C08F 6/00; C08J 3/00; C08G 75/02; C08J 5/00; B27N 5/00

(52) U.S. Cl. 264/85; 526/352; 528/480; 528/481; 264/331.17; 264/102; 264/126; 264/323

(57) ABSTRACT

The present invention provides a thermally crosslinked polymeric material and a medical implant made from such polymeric material having significant crosslinking and substantially no detectable free radial for improved wear and oxidation resistance. A method is disclosed for forming a crosslinked oxidation-resistant polymeric material by placing the polymer material in a heating environment at a temperature above the melting point of the polymeric material for a sufficient time to create free radicals and form crosslinks within the polymer micro-structure followed by a cooling step to eliminate residual free radicals and form crosslinks within the polymer micro-structure. A method of making a crosslinked oxidation-resistant UHMWPE medical implant from a solid form of UHMWPE is also disclosed. Another method of making a crosslinked oxidation-resistant UHMWPE near-finished or finished medical implant by compression molding using UHMWPE resin powder as the starting material is also disclosed. A method to produce non-even crosslink distribution in a thermally crosslinked polymeric material is also disclosed herein.

### BACKGROUND OF THE INVENTION

1. Field of the Invention

This invention relates to oxidation-resistant crosslinked polymeric material in general. More specifically, the invention relates to medical implants formed of a polymeric material, such as polyethylene or more specifically ultra high molecular weight polyethylene (UHMWPE), with enhanced crosslinking and superior oxidation resistance and methods for making the same.

2. Description of the Prior Art

The use of ultra high molecular weight polyethylene (UHMWPE) with metallic alloys in total joint replacements (such as hips or knees), has revolutionized the field of prosthetic implants. Ultra-high molecular weight polyethylene (UHMWPE) is defined in ASTM D 4020 as a linear polyethylene which has a relative viscosity of 2.3 or greater at a solution concentration of 0.05% at 135 degree C. in decahydronaphthalene. The nominal weight—average molecular weight is at least 400,000 and up to 10 million and usually from two to six million. In both laboratory and clinical studies, UHMWPE exhibits superior wear resistance over other polymeric materials. The primary reason for increased wear resistance is due to the fact that the number of tie molecules in the UHMWPE matrix is much greater than that of other polymers (such as HDPE, PP, or nylon). These entangled bridging molecules between crystalline blocks play a major role in load-bearing and wear resistance. In recent years, however, severe adverse effects including osteolysis were found in hip and knee joint replacements caused by fine particles liberated from the UHMWPE bearing surface. Prior art patents, such as U.S. Pat. Nos. 5,414,049, 5,879,400, 6,017,975, 6,228,900, 6,245,276, 6,818,172, 6,849,224, 6,852,772, have shown radiation crosslinked UHMWPE to exhibit improved wear resistance. In these prior arts, gamma or electron beam radiation is applied to UHMWE which is placed in an inert or sensitizing (such as acetylene or hydrogen) environment at room or an elevated temperature. The above prior arts and other literature (see e.g. “Radiation Effects on Polymers,” American Chemical Society, 1991 (Symposium of Aug. 26-31, 1990)) have shown that C—H (carbon-hydrogen) and C—C (carbon-carbon) bond breakages are the two major radiation effects in UHMWPE, with the former as the dominant one. Briefly, the two reaction mechanisms create carbon free radicals on the polymer chain and hydrogen free radicals that separate from the polymer chain. Crosslinks are formed in UHMWPE when carbon free radicals in neighboring chains react with each other. A post-radiation annealing or re-melting step is often followed in the cited prior arts to reduce or completely remove residual free radicals. Without this step, un-crosslinked free radicals would react with oxygen or other reactive species during storage or in vivo, resulting in oxidation and chain scission. These prior arts, however, carry two common drawbacks. In the first aspect, radiation tends to produce adverse material property changes in UHMWPE. Examples of such changes are non-uniformity, reduction in elongation at break, and decreased toughness. In general, electron beam has limited penetration power and often produces non-uniform crosslinking in thick parts. Penetration power of gamma ray is adequate but crosslinking is still non-uniform on the micro-structural level, owing to morphological difference between crystalline and amorphous regions. More specifically, crystalline regions tend to receive a higher level of radiation energy due to a higher density, while free radicals in amorphous regions are more likely to migrate along the polymer chain to form crosslinks with neighboring chains. In addition to crosslinking, scission of C—C links along the polymer backbone takes place during radiation and continues in the post-radiation period. Low-molecular-weight materials may be produced if two or more backbone cleavages occur along the same chain sections, especially for those in the amorphous regions. Production of short chains is increased with an increasing radiation dose as the probability of having more than one C—C cleavages on the same polymer chain goes up. Re-crystallization of the shorter chains often increases the crystallinity in irradiated UHMWPE. In the meantime, tensile properties, such as ultimate tensile strength, elongation at break, and toughness suffer a significant loss (see e.g. “Implant Wear in Total Joint Replacement: Clinical and Biologic Issues, Material and Design Considerations”; Edited by Timothy M. Wright, PhD and Stuart B. Goodman, MD, PhD; A symposium held in October 2000; ISBN number 0-89203-261-8; Publisher: the American Academy of Orthopaedic Surgeons). Most of the property changes cited above are irreversible, even after employing a post-radiation annealing or re-melting step. The inventor believes that a more uniform microstructure would reduce adverse material changes in crosslinked UHMWPE.

The second aspect of drawbacks in the cited prior arts relates to production logistics. Most medical implant manufacturers do not have a radiation facility in house. UHMWPE raw material, pre-forms, or finished products must be transported in and out of an outside radiation service provider. Quality control of the crucial crosslinking step is difficult to monitor or verify under such circumstances.

Another failure mode of total joint replacements observed clinically is the embitterment and rupture of UHMWPE implants induced by oxidation. Virgin UHMWPE is inert to most oxidative reactions. However, implant manufacturers have been using gamma radiation for sterilization of the finished (packaged) product. Radiation produces highly reactive free radicals in UHMWPE making it a target for chemical attacks during storage and in the body. Among the reactions that occur, oxidation-induced chain scission is most detrimental. Not only the UHMWPE matrix becomes brittle, its superior wear resistance is largely lost.

### SUMMARY OF THE INVENTION

The present invention relates to a method for providing a polymeric material with enhanced crosslinking and superior oxidation resistance. More specifically, the invention relates to medical implants formed of a polymeric material, such as polyethylene or more specifically ultra high molecular weight polyethylene (UHMWPE), with improved crosslinking and oxidation resistance. For the purpose of illustration, polyethylene or UHMWPE will be used as an example to describe the invention. However, all the theories and processes described hereafter are applicable to other polymeric materials with thermally stable backbone and side groups (as manifested by a higher degradation temperature than the melting point of the polymeric material), such as polypropylene, polyester, Poly(methyl methacrylate) and nylon, unless otherwise stated.

The inventor discovered that crosslinked polyethylene with superior oxidation resistance can be produced by thermal crosslinking. Thermal crosslinking herein refers to a polymer treatment method where the formation of free radicals (structural units that carry a single unpaired electron) is achieved primarily by a thermal means and the formation of crosslinks is primarily caused by re-combination between generated free radicals. Through experiments, the inventor discovered that when a polyethylene material is placed in a heating environment at a temperature above its melting point for a sufficient time, free radicals will be generated. The heating environment is preferred to be in an oxygen-reducing environment, including inert (such as vacuum, nitrogen, argon, helium, etc) or sensitizing (such as acetylene, hydrogen, ethylene, or hydrogen per-oxide, etc.) environments. Within the homogeneous polymer melt, thermally generated free radicals will react with each other to form crosslinks in a random manner. Additional crosslinks or bonds will be formed by reactions between carbon free radicals and reactive species in the presence of a sensitizing environment. When the desired levels of free radicals and crosslinks are achieved, a cooling step from the elevated temperature is performed. During the cooling step, un-crosslinked free radicals will re-combine to form more crosslinks. The total amount of crosslinks in the polymer can be controlled by varying the temperature, the time duration, the amount of reactive species, or any combination of the three factors in the heat treatment process. As a result, a thermally crosslinked polyethylene having virtually no free radials is produced. Oxidation resistance of the crosslinked polyethylene is as high as that of the virgin polymer. Because free radicals and crosslinks are formed in a random, non-biased manner in the heating and cooling steps, the resultant polymeric micro-structure is uniform and superior. Since these processing steps require only a typical oven having heating and cooling elements with gas purging capability (for inert or sensitizing environment), most implant manufacturers can install it in house. It is noted that in the above process, an oxygen-reducing environment is desirable during the heating and cooling steps in order to avoid oxidative reactions which are active at high temperatures. Also, reactive species in a sensitizing environment in general do not help generate free radicals, but they may participate or facilitate the formation of crosslinks.

It is therefore an object of the invention to provide a polymeric material having significant crosslinks and superior oxidation resistance by thermal crosslinking.

Implant material manufacturers often convert polymer resin powder into rods, slabs, blocks, or other solid forms using extrusion, compression molding, or other solid forming processes. Machining, drilling, patterning, assembling, and other fabrication steps are subsequently employed by implant manufacturers to obtain the final dimensions of the product. It is therefore another object of the invention to provide a method for manufacturing such polymeric medical implants having significant crosslinks and superior oxidation resistance comprising thermal crosslinking steps.

Another common process used by implant manufacturers is to convert the polymer resin powder into near-finished or finished products using compression molding in a single step. It is therefore another object of the invention to provide a method for compression molding such polymeric implants having significant crosslinks and superior oxidation resistance comprising thermal crosslinking steps.

Yet in certain medical applications, a non-even distribution of crosslinks in the polymeric implant is desirable. It is yet another object of the invention to provide a method for manufacturing such polymeric medical implants having significant crosslinks with pre-determined crosslink distribution and superior oxidation resistance comprising thermal crosslinking steps.

The above and other objects, features and advantages of the present invention will be better understood from the following specification in conjunction with the accompanying examples.

### DESCRIPTION OF THE PREFERRED EMBODIMENT

Before specific preferred methods are provided, the following technical information is provided herein to help elucidate the concept of the present invention. In general, when a polymeric material is gradually heated from room temperature towards an elevated temperature, weaker bonds will de-compose before other more stable bonds. Depending on the chemical structure of the polymer and the heating conditions, subsequent chemical reactions may lead to side group elimination, random chain scission, and/or de-polymerization (see e.g. “Thermal Degradation of Polymeric Materials”; Author: K. Pielichowski and J. Njuguna; ISBN: 1-85957-498-X; Published March 2005). Side group elimination changes the fundamental properties of the polymer and is un-desirable in the conventional wisdom for medical implant applications. Random chain scission of backbone C—C links reduces molecular weight and chain length of the polymer and again is un-desirable in the conventional wisdom for medical implant applications. De-polymerization essentially breaks the long-chain polymer down to monomers (or the repeating units of polymer) and again is generally un-desirable in medical applications. As an example, C—Cl and C—H bonds are the weak links in polyvinyl chloride (PVC). Upon heating to about 100 degree C., hydrogen chloride (HCl) is released from the polymer as a result of side group elimination. Upon further heating to a higher temperature above its melting point (about 180 degree C.), de-polymerization with heavy weight loss becomes the dominant mode. Similarly, heat treatment of poly(vinyl alcohol) (PVA) eliminates hydroxyl (OH) side groups first at about 100 degree C. as evidenced by gradual discoloration. Rapid weight loss or de-polymerization occurs when the heating temperature reaches about 180 degree C., just slightly above its melting point at about 160 degree C.

Unlike the above-cited examples and most other polymers, the inventor discovered that polyethylene, and UHMWPE in particular, behaves uniquely in several aspects upon heat treatment. First, the only side group hydrogen itself is highly stable. The C—H bond is even more thermally stable than the long chain backbone C—C bond. The C—H bond energy is well-known to be about 90 Kcal/mole while the C—C bond energy is about 80 Kcal/mole. During a gradual heat-up, breakage of C—C links occurs first and is more pronounced than that of C—H bonds which occurs at a later stage (see e.g. “Molecular Modeling of Polymer Flammability: Application to the Design of Flame-Resistant Polyethylene”, Marc R. Nyden,' Glenn P. Formey, and James E. Brown; Macromolecules 1992, 25, 1658-1666). Secondly, loss of hydrogen through C—H breakage (side group elimination) or release of volatile compounds through C—C cleavage (such as ethylene, propylene, etc.), at a small amount, does not change chemical or physical properties of polyethylene. The chemical structure of (CH2)x (x depicting the number of repeated units) remains intact after such a heat treatment. In fact, both bond breaking mechanisms produce free radicals that are useful in the formation of crosslinks. Thirdly, due to the strong covalent bonds in polyethylene, thermal stability is superior. Large-scale decomposition (or de-polymerization) does not occur until a temperature way above the melting point is reached. Another unique feature of polyethylene, specific to UHMWPE, is that the solid shape of UHMWPE is by and large retained at temperatures close to or significantly above its melting point (at about 130 degree C.). The large amount of chain entanglement in the UHMWPE melt prevents the polymer matrix from flowing or shape-changing. In fact, flow of UHMWPE melt will not occur unless it is subject to external forces, such as in ram extrusion or compression molding.

Based upon these characteristics, the inventor discovered that there exists a processing range in temperature and duration of time where crosslinks in polyethylene can be effectively created. In this processing range, random chain scission of C—C links is the primary source and random breakage of C—H bonds the secondary source of free radicals. In this processing range, bond breaking and crosslink forming are in dynamic equilibrium. In this processing range, net loss of substance from polyethylene is minimal while de-polymerization is negligible. Again in this processing range, total number of crosslinks in polyethylene is determined by the summation of crosslinks formed in the heat treatment step and those in the subsequent cooling step.

Furthermore, the inventor discovered that the micro-structure and material property in crosslinked polyethylene produced by thermal means at a temperature above the melting point, taught by the present invention, differ fundamentally from those by ionizing radiation at a temperature below the melting point (as will be further illustrated in the examples later). Reaction mechanism, micro-structure, and material property are compared for the two crosslinking methods in Table 1.

TABLE 1
Comparison of reaction mechanism, micro-structure,
and material property in crosslinking of polyethylene by ionizing
radiation and thermal means

| Reaction mechanism/ | | |
|---|---|---|
| Micro-structure/ | | |
| Material Property | Ionizing radiation | Thermal means |
| Micro-structure | Two-phase morphology | Homogeneous melt; |
| during treatment | (crystalline and | long chains coiled |
| | amorphous) | and entangled |
| Chain mobility | Highly restricted in | Highly mobile in |
| | crystalline and | random directions |
| | limited in amorphous | |
| | phase | |
| Bond breakage/free | C—H dominant; C—C | C—C dominant; C—H |
| radical formation | secondary | secondary |
| Crosslink | Non-uniform | Uniform |
| distribution | | |
| Formation of short | Significant | Negligible |
| chains | | |
| Crystallinity | Increased with | Maintained or |
| | increasing radiation | decreased depending |
| | dose | on cooling |
| | | conditions |
| Gel content (non- | Increased with | Increased with |
| soluble fraction as | increasing dose but | temperature and |
| determined by | hardly reaching 100% | time; Complete |
| solvent extraction) | | crosslinking (100% |
| | | gel) can be achieved |
| Tensile elongation | Decreased with | Increased, |
| | increasing dose | maintained, or |
| | | decreased depending |
| | | on treatment |
| | | conditions |
| Ultimate tensile | Decreased with | Maintained or |
| strength | increasing dose | decreased depending |
| | | on treatment |
| | | conditions |
| Tensile toughness | Decreased with | Increased, |
| | increasing dose | maintained or |
| | | decreased depending |
| | | on treatment |
| | | conditions |

From the qualitative comparison in Table 1, it is demonstrated that thermally crosslinked polyethylene is a new class of crosslinked polyethylene as compared to prior arts of irradiated crosslinked polyethylene.

In the first preferred method (called Method A hereafter), a solid polymeric material such as UHMWPE, in the form of rods, slabs, or blocks, is obtained as the starting material for thermal crosslinking treatment. In the first step of the invention, the starting material is placed in a heating oven. Air and moisture is then reduced or removed from the interior of the oven. This can be achieved by flushing the oven with an inert gas, such as nitrogen, argon, or helium, for a sufficient time (5 minutes or longer preferred). Alternatively, air and moisture can be removed by applying a vacuum (less than 2″ of mercury (50 torr) preferred) in the oven for a sufficient time (10 minutes or longer preferred). In the second step, heat is provided to raise the temperature in the oven to the pre-determined target temperature above the melting point of UHMWPE (at about 130 degree C.). The inventor discovered that rapid weight loss or de-polymerization, which is to be avoided in the present invention, occurs when the oven temperature exceeds about 400 degree C. Therefore, the preferred temperature range is between 140 and 400 degree C. A more preferred temperature range is between 160 and 350 degree C. for active free radicals and crosslinks formation without noticeable weight loss. It is in general desirable to raise the oven temperature slowly so that the temperature distribution in the oven interior as well as in the polymer solid is uniform. The preferred temperature variation in the polymer solid is less than 20 degree C. In the third step, the oven is maintained at the target temperature for a pre-determined time period. The preferred time period range is between 5 minutes and 24 hours for low temperature ranges of between 160 and 300 degree C.; and between 5 seconds and 2 hours for high temperature ranges of between 300 and 400 degree C. During this time period, carbon free radicals are generated by random chain scissions of backbone C—C or side group breakage of C—H bonds. In the same period, free radicals react with each other (among intra- or inter-molecular chains) to form crosslinks. In the fourth step, cooling is provided to bring the oven temperature back to room temperature or a temperature below the crystallization zone (about 80-120 degree C. for UHMWPE). Any known arts of cooling can be used. The preferred cooling method is by purging the oven with an inert gas, such as nitrogen, argon, or helium, for a sufficient time (20 minutes or longer preferred). During this cooling period, more crosslinks are formed due to reactions of residual free radicals which remain un-crosslinked in the second (heating) and third (holding) steps. Virtually all free radicals are eliminated in the cooling step. Therefore, the total amount of crosslinks is a summation of crosslinks formed in the second (heating), third (holding) and fourth (cooling) steps. In the cooling period, crystallization from melt takes place at a temperature zone below the melting point of polymer (starting at about 120 degree C. and ending at about 80 degree C.) causing polyethylene to become semi-crystalline. The resultant crystallinity is in general similar to or slightly lower than that in the untreated polymer Increased crosslinking and chain entanglement in the treated polymer tends to hinder chain movement thus slows down the crystallization process. The inventor discovered that crystallinity obtained following the cooling step is highly sensitive to the cooling rate at the crystallization temperature zone (between 80 and 120 degree C. for UHMWPE). If a higher crystallinity is desirable, then a slower cooling rate is employed. The preferred cooling rate for high crystallinity is between 0.1 and 5 degree C. per minute. On the other hand, if a lower crystallinity is needed, then a faster cooling rate is used. The preferred cooling rate for low crystallinity is between 5 and 100 degree C. per minute. The preferred method for obtaining low crystallinity is quenching the crosslinked polymer melt in liquid nitrogen, dry ice, or ice-water. Using the above described four steps, a thermally crosslinked polyethylene having virtually non-detecting free radicals is produced. It is a known art that when crosslinking is increased in UHMWPE, wear resistance is increased (see e.g. “Effect of Radiation Dosage on the Wear of Stabilized UHMWPE Evaluated by Hip and Knee Joint Simulators,” Wang A, Polineni V K, Essner A, Sun D C, Stark C, Dumbleton J H, 23rd Annual Meeting of the Society for Biomaterials, April, 1997, New Orleans, La.: 394). It is also a known art that when free radicals are reduced in an irradiated UHMWPE, oxidation resistance is improved (see e.g. “The Concept of Stabilization in UHMWPE”, D. C. Sun, A. Wang, C. Stark, J. H. Dumbleton, paper presented at the 5th World Biomaterials Congress, May 28-Jun. 2, 1996, Toronto, Canada, Vol. 2, Page 195). Thus, a thermally crosslinked UHMWPE solid material having significantly reduced free radicals in the present invention is useful for fabrication into orthopedic implants with improved wear and oxidation resistance. The inventor further discovered that in order to increase the total amount of crosslinks in the polyethylene, a higher oven temperature in the second (heating) step should be used. Similarly, total crosslinks are increased if a longer duration in the third (holding) step is used. The amount of crosslinks in polyethylene is in general analyzed by the solvent extraction method in which polyethylene is heated in a good solvent, such as xylene, decahydronaphthalene, or trichlorobenzene (TCB), to separate solubles (un-crosslinked portion) from insolubles (crosslinked portion or gel content). Boiling xylene as described in ASTM D2765 (Standard Test Methods for Determination of Gel Content and Swell Ratio of Crosslinked Ethylene Plastics) is most used by researchers for determination of gel content in crosslinked polyethylene. The preferred gel content range as measured by boiling xylene in ASTM D2765 for the invention is between 65 and 100%. Also described in ASTM D2765 is a method for determination of swell ratio using heated xylene at 110 degree C. for 24 hours. A lower swell ratio is an indication of a higher crosslinking density and a lower average molecular weight between crosslinks. The preferred swell ratio range for the invention is between 2.0 and 4.0. The inventor also discovered that variation of cooling rate in the fourth (cooling) step is not effective in controlling the total amount of crosslinking. Although a heating oven is the preferred equipment for performing the required four steps in the invention, alternative equipment or apparatus can be utilized to achieve the same treatment purposes. For instance, an oil bath filled with heat-stable oils (such as soybean, corn, or silicone oils; free of moisture preferred) can be employed instead of a heating oven. In this case, polyethylene material in the form of rods, slabs, or blocks is immersed in the oil bath during the four required steps to avoid direct contact with air. Heating and cooling means are provided in the oil bath, similar to those provided in a heating oven. The oily skin of the treated polyethylene is removed by machining or washing. After a thermally crosslinked polyethylene is obtained using the above four steps, implant manufacturers can follow the known arts to machine, drill, assemble, and package polyethylene implants. A small amount of oxidation near the surface of polyethylene material, if exists, can be removed by machining. The last step in implant manufacturing, sterilization, can be done by known arts, such as ethylene oxide, hydrogen peroxide, gas plasma, or gamma radiation. Gamma radiation is the least preferred method of sterilization for the invention, since it adds new free radicals in polyethylene implants. If gamma radiation is used, the implants should be packaged in an oxygen-reducing atmosphere to avoid oxidation during storage. Other non-radiation methods are all suitable for sterilization of thermally crosslinked polyethylene implants.

Implant material manufacturers often convert polymer resin powder into rods, slabs, blocks, or other solid forms using ram extrusion, compression molding, or other solid forming processes. Machining, drilling, and other fabrication steps are subsequently employed by implant manufacturers to obtain the final dimensions or shapes of the implant. Therefore, another preferred method (called Method B hereafter) of the invention is to create crosslinking in the solid forming step using polymer resin powder as the starting material. Method B includes the four similar steps described above in the Method A. All preferred processing and material property ranges are also identical between Methods A and B. Certain processing details for Method B are provided herein. In the first step, polyethylene resin powder is introduced into the receiving apparatus of the forming process (such as the material inlet in the ram extrusion or the mold cavity in the compression molding). Moisture and air in the polymer resin powder should be reduced or removed in the storage container as well as during the solid forming process to avoid oxidation. This can be achieved by flushing the resin container with an inert gas, such as nitrogen, argon, or helium, for a sufficient time (5 minutes or longer preferred). Alternatively, air and moisture can be removed by applying a vacuum (less than 2″ of mercury (50 torr) preferred) in the resin container for a sufficient time (10 minutes or longer preferred). Or, an escape path for air and moisture is provided in the forming process at low temperature zones (below the melting point of polyethylene) where the high processing pressure tends to squeeze out most of gases. Similar to Method A, heating and cooling means are provided in the solid forming process. If heating and cooling are provided along the solid forming path in a series of temperature zones (such as the pre-heating zone, the ram and subsequent heating and cooling zones in ram extrusion), it is important to ensure that the material is exposed to the target temperature (range) for a sufficient time to form required crosslinking. The total amount of crosslinks is controlled by the temperature profile along the solid forming path and the production (extrusion) rate. To completely fuse the resin powder, adequate pressure and temperature is needed in the solid forming process. The inventor discovered that the pressure itself does not create free radicals in polyethylene without the effect of elevated temperature. The inventor further discovered that given sufficient pressure, the temperature needed to create free radicals is in general higher than that needed for complete fusion. Therefore, the target temperature for crosslinking is also suitable for complete fusion in most cases. Similar to Method A, if a lower crystallinity is desirable, a fast cooling rate can be used. Certain implant manufacturers require a high level of dimensional stability of polymer solids upon machining into final dimensions. In such cases, the cooling rate at the crystallization temperature zone (between 80 and 120 degree C.) can still be set at a high value (such as 10 degree C. per minute) for obtaining low crystallinity, but a post-forming annealing step at a temperature below the melting point (such as 110 degree C.) is recommended for increased dimensional stability.

Another common process used by implant manufacturers converts the polymer resin powder into near-finished or finished products using compression molding in a single step operation. The term “near finished product” refers to an inter-mediate product where the primary shape or dimension of the product has been achieved but certain minor product details (such as holes, flanges, etc.) are to be completed. Implant products made by this method include acetabular cups and knees in orthopedic applications. Fusion defects are less in general for this fabrication method working with a small volume of material, as compared to those in implants machined from rods, slabs, or blocks formed by ram extrusion or compression molding. Therefore, another preferred method (called Method C hereafter) of the invention is to create crosslinking in the compression molding step using polymer resin powder as the starting material. Method C includes the four similar steps described above in the Methods A and B. All preferred processing and material property ranges are also identical between Methods A, B, and C. Processing details are in general similar between Method C and the compression molding in Method B except that Method C works with a small volume while Method B with a large volume of material. Due to a smaller volume, temperature uniformity in the mold can be readily obtained in Method C. Cooling rate is also easier to control for the same reason. Since the final dimension of the product is formed in the compression mold (essentially no machining is followed post-molding), care must be taken to ensure that the required dimensions are obtained after the cooling step. Shrinkage of the material in the cooling step, which varies with cooling rate, must be taken into account.

It has been shown that certain material properties of polyethylene exhibit adverse changes upon crosslinking. One of these un-desirable property changes is fracture toughness, which decreases with increasing crosslinking (see e.g. “A comparison of the fracture toughness of cross-linked UHMWPE made from different resins, manufacturing methods and sterilization conditions”; Duus, L. C., Walsh, H A; Gillis, A M; Noisiez, E; Li, S; Sixth World Biomaterials Congress; Kamuela, Hi.; USA; 15-20 May 2000. 384 pp. 2000). Although toughness in the thermally crosslinked polymeric material in the present invention is either improved or maintained in general, ultimate tensile strength could be reduced for certain treatment conditions (as demonstrated in Example 6 below). To avoid unwanted material change while improving wear, a non-even distribution of crosslinks in the implant polymer matrix is desirable in certain applications. For instance, the articulating surface of an acetabular cup (the central concave portion) can be made crosslinked for wear resistance, while the rim or flange be less-crosslinked or non-crosslinked for hole drilling and against high contact stress. Another example favoring a non-even crosslink distribution is tibial inserts in knee applications. Wear resistance or high crosslinking is needed on the bearing surface (against movement of a femoral component) while the base portion (which is often fitted or screw-fixed into a metallic plate) requires mechanical strength and is preferably less-crosslinked. Based upon the four treatment steps described in Methods A through C, the amount of crosslinks is readily controlled by temperature and duration. In general, any known arts of heating and cooling means can be employed to create a desirable temperature distribution in a planer (2-D) or three-dimensional (3-D) configuration. Exposure time for each sub-area at target temperature can also be controlled individually by known arts to obtain the needed crosslink distribution. As an example, in the thermal crosslinking treatment of UHMWPE slabs (Method A), instead of uniform heating, only the top surface of the slab is heated, while cooling (or less heating) is provided at the bottom surface of the slab so that a temperature gradient, from high at top to low at bottom, is effectively created. A corresponding crosslink distribution in the slab, from high at top to low at bottom, is effectively produced. This type of UHMWPE slabs is useful as a starting material for machining into tibial inserts. Yet as another example, in the compression molding of acetabular cups from polymer resin powder (Method C), instead of uniform heating, intensive heating is provided at the bearing surface of the cup while less heating is provided at the rim or flange regions, thus creating a crosslinking distribution concentrated in the articulating region where wear resistance is most needed. Besides the control of crosslinking, it is to be noted that a minimum temperature (and pressure) is in general needed to facilitate complete fusion of resin particles. There are several known processes that have been used for improvement of polymeric materials. These include ultrasound, infrared, microwave, mechanical deformation, uni-directional drawing, bi-axial drawing, orientation, and electromagnetic field. However, none of the above cited processes or alike can act alone to create noticeable amount of free radicals in the polymeric material. Subsequently, significant crosslinking can not be created using any of these known processes alone. Therefore, combination of any of theses known arts with a thermal means taught by the invention for the purpose of crosslinking, is deemed part of the invention.

It is to be understood that the description, specific examples and test data, while indicating exemplary aspects, are merely illustrative of the principles and applications and are not intended to limit the present invention. Various changes and modifications within the present invention will become apparent to the skilled artisan from the discussion, disclosure and data contained herein, and thus are considered part of the invention as defined by the appended claims.

### EXAMPLES

### Example 1

### Weight Loss

### Objective

This example investigates the characteristics of weight loss of UHMWPE material upon heat treatment

### Material and Method

A TGA (Thermogravimetric analysis) instrument (DuPont Co., model 951) was used to measure weight loss as function of temperature and time. Two materials were tested. The first material (Material A) was a surgical grade UHMWPE resin powder without any treatment. The second material (Material B) was a surgical grade UHMWPE rod produced by ram extrusion. For Material A, sample weights between 10 and 20 mgs were used. For Material B, thin films (about 200 to 400 microns) cut from the UHMWPE rod surface with weights between 10 and 20 mgs were used. In each TGA test, the sample was first placed in the TGA sample tray and purged in nitrogen gas for ten minutes. Under nitrogen atmosphere, temperature was then raised at 40 degree C./min from room temperature to the target temperature (160, 200, 250, 275, 300, 400 degree C.) and held at the target temperature for 30 minutes. The total weight loss (% of original weight) was recorded and reported.

### Result and Discussion

### % Weight Loss is Tabulated in Table 2.

TABLE 2
Weight loss as function of temperature for UHMWPE

| Temperature | % Wt. Loss | % Wt. Loss |
|---|---|---|
| (Degree C.) | (Material A) | (Material B) |
| 160 | negligible | negligible |
| 200 | negligible | negligible |
| 250 | 0.3 | negligible |
| 275 | 1.3 | negligible |
| 300 | 2.0 | 1.1 |
| 400 | 10.2 | 6.3 |

From Table 2, it can be seen that weight loss in UHMWPE resin powder (Material A) upon heat treatment in nitrogen was undetectable at temperatures below 200 degree C. A small amount of weight loss (about 2% or less) was observed at temperatures between 200 and 300 degree C. Rapid weight loss (about 10% in 30 minutes), an indication of active decomposition or de-polymerization was seen at 400 degree C. Similar trends were discovered for the UHMWPE extruded rod (Material B), except that weigh loss was undetectable until the temperature was at 300 degree C. or higher and that the weight loss was less for Material B than Material A at a given temperature. The reason for reduced net weight loss in Material A was thought to due to its dense solid structure, which could block the low molecular material produced by the heat treatment from escaping. It is highly probable that these low molecular weight materials are either in the form of free radicals or in the state of high reactivity, and thus can react with other carbon free radicals in the polymer matrix. It is concluded that temperatures below 400 degree C. are most suitable for thermal crosslinking without significant weight loss.

### Example 2

### Gel Content

### Objective

This example studies the extent of crosslinking in UHMWPE

### Material and Method

Procedures listed in ASTM D 2765 (Standard Test Methods for Determination of Gel Content and Swell Ratio of Crosslinked Ethylene Plastics) were followed to determine the gel content in UHMWPE. Briefly, a polymer sample placed in a stainless pouch was immersed in boiling xylene for 24 hours. Following solvent extraction and drying, gel content (insoluble or crosslinked portion, %) was determined by dividing the dried weight with the original sample weight. Thin plates (about 0.5-1.0 mm thick) cut from a surgical grade UHMWPE slab produced by compression molding were used. Sample weights were kept at between 2.0 and 3.0 g. Each sample underwent a thermal crosslinking treatment according to the preferred Method A described earlier. Briefly, UHMWPE samples (Samples A, B, and C) were placed in a heating oven. The oven was purged with nitrogen for 10 minutes. Oven temperature was raised to the target temperature (140, 220, 300 degree C. for Samples A, B, and C respectively) and held for 60 minutes. Samples were naturally cooled in the oven (average cooling rate estimated at about 3 degree C./min) and taken out at room temperature. To investigate the effect of cooling on crosslinking, another sample (Sample D) was taken out from the oven after the heating and the holding steps, and immediately immersed in an ice-water bath. The treatment temperature for Sample D was 220 degree C. All other procedures were identical to Sample B. To investigate the effect of a sensitizing environment on crosslinking, one sample (Sample E) was purged with a gas mixture of 2% acetylene and 98% nitrogen by volume and kept in this gas environment during the heating and cooling steps. The treatment temperature for Sample E was at 300 degree C. All other procedures were identical to Sample C. An untreated sample (Sample F; cut from a surgical grade UHMWPE slab produced by compression molding) was also included as the reference.

### Result and Discussion

% Gel Content is Tabulated in Table 3:

TABLE 3
Gel content of UHMWPE following thermal crosslinking

| Sample | Treatment | Gel content, % |
|---|---|---|
| A | 140 degree C./ | 64.8 |
| | Nitrogen/Slow | |
| | cooling | |
| B | 220 degree C./ | 93.5 |
| | Nitrogen/Slow | |
| | cooling | |
| C | 300 degree C./ | 100.0 |
| | Nitrogen/Slow | |
| | cooling | |
| D | 220 degree C./ | 93.2 |
| | Nitrogen/Fast | |
| | cooling | |
| E | 300 degree C./2% | 99.9 |
| | acetylene/Slow | |
| | cooling | |
| F | Untreated (as | 65.2 |
| | compression | |
| | molded) | |

From Table 3, the gel content in the untreated (as compression molded) sample (Sample F) was at about 65%. Gel content did not change when the UHMWPE sample (Sample A) was treated at a temperature close to the melting point (UHMWPE's melting point at 130-140 degree C. while Sample A treated at 140 degree C.). Crosslinking was increased significantly when the treatment temperature was increased to 220 degree C. (Sample B with gel content of about 93%). Complete crosslinking or near 100% gel content was obtained when the treatment temperature was at 300 degree C. (Sample C). It is to be noted that in irradiated crosslinked UHMWPE, gel content (analyzed by the same method as in this example), may vary between 60 and 98% but hardly reach 100% (see e.g. U.S. Pat. No. 6,800,670). In contrast, complete crosslinking or near 100% gel content can be readily obtained in chemical crosslinking (see “Shen, F. W. et al. J. of Poly. Sci. Part B: Poly Phys 34:1063-1077 (1996). It is thought that low molecular weight material produced by chain scission in ionizing radiation is responsible for the solubility seen at low or high radiation doses. In the invention, random free radical formation, uniform crosslinking, and complete elimination of free radicals (as illustrated by ESR in the Example 3 below) result in 100% gel content evidenced by Sample C. Cooling rate had little effect on gel content, as the gel content of Sample D (ice-water quenching) was virtually identical to that of Sample B (slow cooling), all at about 93%. Also, the sensitizing environment (2% acetylene by volume) used in the treatment of Sample E was as effective as the inert environment (nitrogen) used for Sample C, as both samples showed virtually 100% gel content. It is concluded that (1) a combination of heating, holding, and cooling steps as disclosed in the invention is an effective means of producing crosslinks in UHMWPE (2) a higher temperature results in a higher gel content, (3) cooling rate has little effect on the extent of crosslinking, (4) both inert and sensitizing environments are effective in the thermal crosslinking process, and (5) complete crosslinking or 100% gel content can be achieved in the invention.

### Example 3

### Free Radicals

### Objective

This example measures free radical concentrations in UHMWPE

### Material and Method

An ESR equipment (BRUKER/EMX-10) calibrated with DPPH (2,2-Diphenyl-1-Picrylhydrazyl) was used to measure free radical concentrations in UHMWPE. Four samples with sample weights between 0.8 and 1.2 g were tested. Sample A comprised of thin films cut from a surgical grade UHMWPE slab produced by compression molding was tested without any treatment (un-treated). Sample B (thin films cut from the same molded slab as Sample A) was treated by the same procedures used for the Sample B in Example 2 (treatment temperature 220 degree C. for 60 minutes in nitrogen with slow cooling). Sample C (thin films cut from the same molded slab as Sample A) was treated by the same procedures used for the Sample C in Example 2 (treatment temperature 300 degree C. for 60 minutes in nitrogen with slow cooling). Sample D consisted of thin films cut from the skin of a tibial insert made of a surgical grade UHMWPE gamma-ray irradiated at 150 kGy in air at room temperature. All ESR tests were conducted at room temperature.

### Result and Discussion

Free Radical Concentrations are Tabulated in Table 4:

TABLE 4
Free radical concentrations in UHMWPE

| | | Free radical |
|---|---|---|
| | | concentration |
| Sample | Treatment | (10.sup.15 spin/g) |
| A | Untreated (as | Undetectable* |
| | compression | |
| | molded) | |
| B | 220 degree C./ | Undetectable* |
| | Nitrogen/Slow | |
| | cooling | |
| C | 300 degree C./ | Undetectable* |
| | Nitrogen/Slow | |
| | cooling | |
| D | irradiated at 150 kGy | 125 |
| | in air at room | |
| | temperature | |

Note
the detection limit of free radical concentration (minimum level) for the ESR instrument is estimated at 1.0.times.10.sup.15 spin/gram.

From Table 4, it can be seen that the untreated reference sample (Sample A) contained no free radicals. Also, no free radicals were detected in the two samples (Samples B and C) treated by the Method A disclosed in the present invention. In contrast, gamma-ray irradiated Sample D showed a significant number of free radicals (125×10.sup.15 spin/g). It is concluded that the cooling step disclosed in the invention is effective for the recombination of free radicals left un-crosslinked after the heating and the holding steps.

### Example 4

### Oxidation Index

### Objective

This example investigates the extent of oxidation in UHMWPE

### Material and Method

A FTIR (Fourier Transform infrared spectroscopy) spectrophotometer (Nicolet Avatar 320) was used to measure oxidation index in UHMWPE. Detailed procedures are listed in ASTM 2102. Briefly, oxidation index is defined as the ratio of the peak area at 1716 cm**−1 (carbonyl group) to the peak area at 1464 cm**−1 (methyl group). Four samples (Samples A through D) as defined in Example 3 in the form of thin films were analyzed by FTIR. To test the effect of aging, procedures listed in ASTM F2003 were employed. Briefly, Samples B, C, and D were aged in an air oven at 80 degree C. for 11 days and then analyzed (designated as Sample B-aged, Sample C-aged, and Sample D-aged respectively).

### Result and Discussion

Oxidation Indices are Tabulated in Table 5:

TABLE 5
Oxidation index in UHMWPE

| Sample | Treatment | Oxidation index |
|---|---|---|
| A | Untreated (as | Below 0.01 |
| | compression | |
| | molded) | |
| B | 220 degree C./ | Below 0.01 |
| | Nitrogen/Slow | |
| | cooling | |
| C | 300 degree C./ | Below 0.01 |
| | Nitrogen/Slow | |
| | cooling | |
| D | Irradiated at 150 kGy | 0.07 |
| | in air at room | |
| | temperature | |
| B-aged | 220 degree C./ | Below 0.01 |
| | Nitrogen/Slow | |
| | cooling/aged in | |
| | air oven at 80 | |
| | degree C. for 11 | |
| | days | |
| C-aged | 300 degree C./ | Below 0.01 |
| | Nitrogen/Slow | |
| | cooling/aged in | |
| | air oven at 80 | |
| | degree C. for 11 | |
| | days | |
| D-aged | Irradiated at 150 kGy | 0.15 |
| | in air at room | |
| | temperature/aged | |
| | in air oven at 80 | |
| | degree C. for 11 | |
| | days | |

From Table 5, it can be seen that the starting untreated sample (Sample A) was oxidation-free. All four invention-related samples (Samples B, C, B-aged, C-aged) showed no sign of oxidation. Since ESR results in Example 3 showed Samples B and C to contain no free radicals, it comes no surprise that superior oxidation resistance was observed for these two materials. In contrast, significant oxidation (oxidation index 0.07 before aging and 0.15 after aging) was detected in the gamma-ray irradiated sample (Sample D). It is concluded that thermal crosslinking steps disclosed in the invention produces UHMWPE material with superior oxidation resistance.

### Example 5

### DSC

### Objective

This example examines melting temperature and crystallinity in UHMWPE

### Material and Method

A DSC (differential scanning calorimetry) instrument (TA Instruments, Q10) was used to obtain the melting trace of UHMWPE. Melting temperature was determined as the peak temperature of the melting trace curve. The heat of fusion was calculated through an integration of the area under the melting peak between 70 degree C. and 145 degree C. Crystallinity was calculated using the heat of fusion divided by 287 J/g, the heat of fusion of an ideal polyethylene crystal. Sample weights were kept between 4 and 6 mgs. A ram-extrusion produced UHMWPE rod was used as the starting material. 1-mm thick plates were machined from the rod for sample preparation. Sample A was analyzed without any treatment (un-treated). Three other plate samples (Samples B, C, and D) were treated according to the preferred Method A. Briefly, UHMWPE samples were placed in a heating oven. The oven was purged with nitrogen for 10 minutes. Oven temperature was raised to the target temperature (230, 250, 275 degree C. for Samples B, C, and D respectively) and held for 60 minutes. Samples were cooled in the oven at a controlled cooling rate of 1 degree C./min and taken out at room temperature. To investigate the effect of cooling on crystallinity, three more plate samples (Samples B-quenched, C-quenched, and D-quenched) were treated using the identical heating and the holding steps as for Samples B, C, and D respectively, but the cooling step was done by quenching the samples in an ice-water bath.

### Result and Discussion

Melting Temperature and Crystallinity are Tabulated in Table 6:

TABLE 6
Melting temperature and crystallinity of UHMWPE

| | | Melting | |
|---|---|---|---|
| | | Temperature, | Crystal- |
| Sample | Treatment | degree C. | linity, % |
| A | Untreated (as | 142 | 51.2 |
| | extruded) | | |
| B | 230 degree C./ | 140 | 50.5 |
| | Nitrogen/Slow | | |
| | cooling | | |
| C | 250 degree C./ | 142 | 50.9 |
| | Nitrogen/Slow | | |
| | cooling | | |
| D | 275 degree C./ | 141 | 50.5 |
| | Nitrogen/Slow | | |
| | cooling | | |
| B-quenched | 230 degree C./ | 131 | 43.6 |
| | Nitrogen/ | | |
| | quenched in | | |
| | ice-water | | |
| C-quenched | 250 degree C./ | 132 | 42.9 |
| | Nitrogen/ | | |
| | quenched in | | |
| | ice-water | | |
| D-quenched | 275 degree C./ | 130 | 44.3 |
| | Nitrogen/ | | |
| | quenched in | | |
| | ice-water | | |

From Table 6, the untreated UHMWPE material (as extruded) has a melting peak temperature of 142 degree C. and crystallinity of about 51%. Upon thermal crosslinking with a slow cooling rate (1 degree C. per minute), the melting temperature was little changed for Samples B, C, and D (in the range of 140-142 degree C.). Similarly, crystallinity in Samples B, C, and D was very close to that of the untreated Sample A (varying from 50.5 to 50.9%). As discussed earlier, crystallinity tends to increase upon radiation in irradiated crosslinked UHMWPE. Low molecular weight material produced by radiation is thought to cause a finite solubility in solvent extraction tests (that is, gel content below 100%) and an increase in crystallinity (short chain re-crystallization). In strong contrast, thermally crosslinked UHMWPE of the invention readily achieved 100% gel content (see Table 3 in Example 2) and showed no increase in crystallinity, even though a slow cooling rate (1 degree C. per minute) was used. Combination of the above observations suggests that thermal crosslinking produces a negligible amount of short chain materials. The data in Table 5 also shows that a lower crystallinity can be obtained by quenching. The crystallinity in the three quenched samples (Sample B-quenched, Sample C-quenched, and Sample D-quenched) varied from 42.9 to 44.3%, as compared to a range between 50.5 and 50.9% for the slowly cooled counterparts (Samples B, C, and D). It is noted that all test samples in this example showed a single melting peak, indicating that UHMWPE consisted of a single primary microstructure before and after thermal crosslinking treatments. It is concluded that (1) melting temperature and crystallinity in UHMWPE are essentially unchanged when a slow cooling rate is used in the thermal crosslinking process, and (2) a lower crystallinity in thermally crosslinked UHMWPE can be obtained by quenching.

### Example 6

### Tensile Property

### Objective

This example measures tensile properties in UHMWPE

### Material and Method

An universal testing machine (Instron, Model 4468) was employed to conduct tensile tests. Sample preparation and test procedures followed ASTM D638. Type-V specimen configuration at thickness of 1-mm was used. Each tensile specimen was machined from the core of tibial inserts machined from a ram-extruded UHMWPE rod. Four sample treatment conditions (Samples A, B, C, and D) as defined in Example 5 (Samples A, B C, D) were used. Average results and standard deviations (in parentheses) from four tensile specimens for each sample treatment condition were reported. The crosshead speed was set at 2-inch per minute.

### Result and Discussion

Tensile Properties are Tabulated in Table 7.

TABLE 7
Tensile properties of UHMWPE

| | | Tensile | Ultimate | | |
|---|---|---|---|---|---|
| | | yield | tensile | Elongation | Tensile |
| | | strength, | strength, | at break, | toughness, |
| Sample | Treatment | MPa | MPa | % | MJ/M.sup.3 |
| A | Untreated | 22.8 (0.6) | 51.1 (3.7) | 491 (32) | 172.8 (19.9) |
| | (as | | | | |
| | extruded) | | | | |
| B | 230 degree | 23.0 (0.8) | 45.6 (4.1) | 580 (46) | 177.4 (30.5) |
| | C./ | | | | |
| | Nitrogen/ | | | | |
| | Slow | | | | |
| | cooling | | | | |
| C | 250 degree | 23.3 (1.1) | 52.7 (4.7) | 640 (47) | 226.5 (35.2) |
| | C./ | | | | |
| | Nitrogen/ | | | | |
| | Slow | | | | |
| | cooling | | | | |
| D | 275 degree | 21.8 (1.3) | 38.4 (2.9) | 544 (18) | 148.6 (16.6) |
| | C./ | | | | |
| | Nitrogen/ | | | | |
| | Slow | | | | |
| | cooling | | | | |

(Note: values in parentheses are standard deviations)

From the data in Table 7, not much change in tensile yield strength was observed between the untreated UHMWPE (Sample A) and the thermally crosslinked UHMWPE (Samples B, C, and D). All yield strength fell in the range of 21.8 to 23.3 MPa. As cited earlier from literature, tensile yield strength tends to increase with increasing radiation dose in irradiated crosslinked UHMWPE (see e.g. “Implant Wear in Total Joint Replacement: Clinical and Biologic Issues, Material and Design Considerations”; Edited by Timothy M. Wright, PhD and Stuart B. Goodman, MD, PhD; A symposium held in October 2000; ISBN number 0-89203-261-8; Publisher: the American Academy of Orthopaedic Surgeons). In general, crystallinity is positively correlated with tensile yield. As discussed earlier in Example 5, crystallinity increases in irradiated crosslinked UHMWPE, but remains virtually unchanged in thermally crosslinked UHMWPE with a slow cooling step. The tensile yield strength data in Table 7 is consistent with the trend predicted by crystallinity.

Also from Table 7, ultimate tensile strength in thermally crosslinked UHMWPE was either substantially equivalent to or lower than that of the un-treated sample in view of average results and standard deviations. Samples B and C (at 45.6 and 52.7 MPa, respectively) were close to the un-treated Sample A (at 51.1 MPa), while Sample D (at 38.4 MPa) was lower. Uniform crosslinking in the thermally crosslinked material makes it possible to retain much of the tensile strength until a critical crosslinking density is exceeded. In contrast, ultimate tensile strength decreases with low or high radiation doses in irradiated crosslinked UHMWPE, as discussed earlier.

Also from Table 7, elongation at break in thermally crosslinked UHMWPE could be higher than or close to that of the un-treated sample in view of average results and standard deviations. Samples B and C (at 580 and 640% respectively) were higher than the un-treated Sample A (at 491%). Sample D (at 544%) was slightly higher than Sample A but the difference was below statistical significance.

Tensile toughness, defined as the area under the stress-strain curve, is a measure of energy needed to break the tested material. From Table 7, it can be seen that thermally crosslinked UHMWPE could have a higher, similar or lower tensile toughness compared to that of the un-treated UHMWPE. Toughness in Sample B (at 177.4 MJ/M.sup.3) was fairly close to that in the un-treated Sample A (at 172.8 MJ/M.sup.3). Sample C (at 226.5 MJ/M.sup.3) was higher than Sample A, while Sample D (at 148.6 MJ/M.sup.3) was lower. It is noted that the loss of toughness in Sample D, the worst case in this example, is about 14% using the starting material Sample A as the basis. In contrast, loss of toughness in irradiated crosslinked UHMWPE has been reported to be as high as 50% due primarily to non-uniform and strained crosslinks distribution (see e.g. U.S. Pat. No. 6,849,224). It is concluded qualitatively that (1) tensile yield strength is essentially maintained, (2) ultimate tensile strength is either maintained or decreased, (3) elongation at break is increased or maintained, and (4) toughness is increased, maintained, or decreased in UHMNWPE material upon thermal crosslinking at treatment conditions described in this example.

### Example 7

### Non-Even Crosslink Distribution

### Objective

This example presents an example for producing thermally crosslinked UMWPE with non-even crosslink distribution.

### Material and Method

A rectangular block of UHMWPE sample with the dimension of about 50 mm (length)×50 mm (width)×30 mm (thickness) was machined from a compression molded slab. The UHMWPE sample was placed on a hot plate with its bottom surface (one of the two 50 mm×50 mm surfaces) in direct contact with the heating top of the hot plate. The assembly was then inserted into a non-heating oven at room temperature purged with nitrogen. The oven door was then closed while nitrogen purging continued at a positive pressure. The thermal crosslinking step followed the preferred Method A. Briefly, at the beginning the hot plate temperature was raised from room temperature to the target temperature of 300 degree C. After reaching the target temperature, the hot plate was held at 300 degree C. for 60 minutes. The hot plate was then turned off allowing the assembly in the oven to cool down naturally. The UHMWPE sample was then taken out at room temperature for analysis. A thin plate (about 1-mm thick) was cut from the bottom surface of the treated UHMWPE block and designated as Sample A. Another thin plate ((about 1-mm thick) was cut from the top surface of the treated UHMWPE block and designated as Sample B. Procedures in ASTM D 2765 (Standard Test Methods for Determination of Gel Content and Swell Ratio of Crosslinked Ethylene Plastics) as described in Example 2 were followed to determine the gel content in UHMWPE samples.

### Result and Discussion

Gel Content Data are Tabulated in Table 8:

TABLE 8
Gel content of UHMWPE

| Sample | Treatment | Gel content, % |
|---|---|---|
| A | 300 degree C./ | 100.0% |
| | Nitrogen/Natural | |
| | cooling/Bottom | |
| B | 300 degree C./ | 66.3% |
| | Nitrogen/Natural | |
| | cooling/Top | |

From Table 8, the bottom surface sample (Sample A) showed complete crosslinking (gel content of 100%), due to its direct contact with the hot plate at 300 degree C. In contrast, the top surface sample (Sample B) showed a gel content (66.3%) that was very close to that of the untreated sample (65.2%) as analyzed and reported in Table 3 of Example 2. During the heat treatment steps, the top surface of the UHMWPE block was in contact with flowing nitrogen at room temperature, and thus not thermally crosslinked. It is concluded that an UHMWPE material with non-uniform crosslink distribution can be produced using the method disclosed in the present invention.

What is claimed is:

1. A method for producing a polymeric material formed from an olefinic compound and the material having significant crosslinking and improved oxidation resistance, it comprises the steps of:
heating the polymeric material in an oxygen reduced atmosphere for a predetermined time at a temperature above the melting point of said polymeric material to generate free radicals and form cross-links in the polymer micro-structure; and
cooling the heated polymeric material in an oxygen reduced atmosphere from said temperature to eliminate free radicals and form crosslinks in the polymer micro-structure.

2. The method of claim 1, wherein said polymeric material is ultra high molecular weight polyethylene having a molecular weight of at least 400,000.

3. The method of claim 2, wherein said melting point is between 100 degree C. and 140 degree C.

4. The method of claim 1, wherein said predetermined temperature is between 140 degree C. and 400 degree C.

5. The method of claim 1, wherein said predetermined time is between 5 seconds and 24 hours.

6. The method of claim 1, wherein said oxygen reduced atmosphere has no more than 2% oxygen.

7. The method of claim 6, wherein said oxygen reduced atmosphere is made up of an inert gas selected from the group consisting of nitrogen, helium, argon, and a combination thereof.

8. The method of claim 6, wherein said oxygen reduced atmosphere is a sensitizing environment made up of a gas selected from the group consisting of acetylene, ethylene, hydrogen, and a combination thereof.

9. The method of claim 8, wherein said sensitizing environment is made up of a gas mixture comprising 2% volume of acetylene and 98% volume of nitrogen.

10. The method of claim 6, wherein said oxygen reduced atmosphere is produced by a vacuum of less than 2 inches of mercury.

11. The method of claim 1, wherein the level of free radicals in said polymeric material is less than 1.0.times.10.sup.15/gram and the polymeric material has a non-increasing FTIR (Fourier Transform Infra-red Spectroscopy) oxidation index of less than 0.01 which does not increase with oven aging in air at 80 degree C. for up to 11 days.

12. The method of claim 2, wherein the polymeric material has a gel content of higher than 65% measured by boiling xylene extraction.

13. The method of claim 1, wherein said heating is applied to the polymeric material uniformly with a temperature variation within the polymeric material of less than 20 degree C. during heating.

14. The method of claim 1, wherein said heating is applied to the polymeric material non-uniformly with a temperature variation within the polymeric material of higher than 20 degree C. during heating and the gel content in the polymeric material measured by boiling solvent extraction is non-uniform.

15. The method of claim 14, wherein the gel content in the polymeric material measured by boiling xylene varies between 65% and 100%.

16. The method of claim 1, wherein said cooling rate is 1 degree C. per minute or lower.

17. The method of claim 1, wherein said cooling step is achieved by quenching.

18. A method for producing a medical implant made from a solid olefinic material having a molecular weight of between 400,000 and 10,000,000, it comprises the steps of:
heating the solid olefinic material in an oxygen reduced atmosphere for a predetermined time at a temperature above the melting point of said olefinic material to generate free radicals and form cross-links in the polymer micro-structure;
cooling the heated olefinic material in an oxygen reduced atmosphere from said temperature to eliminate free radicals and form crosslinks in the polymer micro-structure; and
fabricating the medical implant from the cooled olefinic material.

19. The method of claim 18, wherein the solid olefinic material is ultra high molecular weight polyethylene.

20. The method of claim 19, wherein ultra high molecular weight polyethylene is in the form of rod, slab, or block.

21. The method of claim 18, wherein said fabricating step is machining, drilling, patterning, fashioning, polishing, assembling, or a combination thereof.

22. The method of claim 18, wherein said predetermined temperature is between 160 degree C. and 350 degree C.; and said predetermined time is between 5 seconds and 24 hours.

23. The method of claim 18, wherein said oxygen reduced atmosphere has no more than 2% oxygen.

24. The method of claim 23, wherein said oxygen reduced atmosphere is made up of an inert gas selected from the group consisting of nitrogen, helium, argon, and a combination thereof.

25. The method of claim 23, wherein said oxygen reduced atmosphere is a sensitizing environment made up of a gas selected from the group consisting of acetylene, ethylene, hydrogen, and a combination thereof.

26. The method of claim 23, wherein said oxygen reduced atmosphere is a sensitizing environment made up of a gas mixture comprising 2% volume of acetylene and 98% volume of nitrogen.

27. The method of claim 23, wherein said oxygen reduced atmosphere is produced by a vacuum of less than 2 inches of mercury.

28. The method of claim 18, wherein the level of free radicals in said medical implant is less than 1.0.times.10.sup.15/gram and the medical implant has a non-increasing FTIR (Fourier Transform Infra-red Spectroscopy) oxidation index of less than 0.01 which does not increase with oven aging in air at 80 degree C. for up to 11 days.

29. The method of claim 19, wherein the medical implant has a gel content of higher than 65% measured by boiling xylene extraction.

30. The method of claim 18, wherein said heating is applied to the olefinic material uniformly with a temperature variation within the olefinic material of less than 20 degree C. during heating.

31. The method of claim 18, wherein said heating is applied to the olefinic material non-uniformly with a temperature variation within the olefinic material of higher than 20 degree C. during heating.

32. The method of claim 31, wherein the gel content in the medical implant measured by solvent extraction is non-uniform and the gel content in the medical implant measured by boiling xylene varies between 65% and 100%.

33. The method of claim 18, wherein said cooling rate is 1 degree C. per minute or lower.

34. The method of claim 18, wherein said cooling step is achieved by quenching.

35. A method for producing a medical implant made from a powder olefinic material having a molecular weight of between 400,000 and 10,000,000, it comprises the steps of:
placing the powder olefinic material in a forming device;
removing air and moisture from the powder olefinic material;
forming the solid olefinic material from the powder olefinic material by simultaneously applying sufficient pressure and heat in said forming device in an oxygen reduced atmosphere for a predetermined time at a temperature above the melting point of said powder olefinic material to generate free radicals and form cross-links in the polymer micro-structure;
cooling the formed olefinic material in an oxygen reduced atmosphere from said temperature to eliminate free radicals and form crosslinks in the polymer micro-structure; and
fabricating the medical implant from the cooled olefinic material.

36. The method of claim 35, wherein the powder olefinic material is resin powder of ultra high molecular weight polyethylene.

37. The method of claim 35, wherein said air and moisture is removed by flushing said powder olefinic material with an inert gas selected from the group consisting of nitrogen, helium, argon and a combination thereof, or by applying a vacuum of less than 2 inches of mercury to said powder olefinic material.

38. The method of claim 35, wherein said forming step is ram extrusion or compression molding.

39. The method of claim 35, wherein said pressure is between 6.9 MPa (1000 psi) and 69 MPa (10,000 psi); said predetermined temperature is between 160 degree C. and 350 degree C.; and said predetermined time is between 5 seconds and 24 hours.

40. The method of claim 35, wherein said fabricating step is machining, drilling, patterning, fashioning, polishing, assembling, or a combination thereof.

41. The method of claim 35, wherein said oxygen reduced atmosphere has no more than 2% oxygen.

42. The method of claim 41, wherein said oxygen reduced atmosphere is made up of an inert gas selected from the group consisting of nitrogen, helium, argon, and a combination thereof.

43. The method of claim 41, wherein said oxygen reduced atmosphere is a sensitizing environment made up of a gas selected from the group consisting of acetylene, ethylene, hydrogen, and a combination thereof.

44. The method of claim 43, wherein said sensitizing environment is made up of a gas mixture comprising 2% volume of acetylene and 98% volume of nitrogen.

45. The method of claim 41, wherein said oxygen reduced atmosphere is produced by a vacuum of less than 2 inches of mercury.

46. The method of claim 35, wherein the level of free radicals in said medical implant is less than 1.0.times.10.sup.15/gram and the medical implant has a non-increasing FTIR (Fourier Transform Infra-red Spectroscopy) oxidation index of less than 0.01 which does not increase with oven aging in air at 80 degree C. for up to 11 days.

47. The method of claim 36, wherein the medical implant has a gel content of higher than 65% measured by boiling xylene extraction.

48. The method of claim 35, wherein said heating is applied to the olefinic material uniformly with a temperature variation within the olefinic material of less than 20 degree C. during heating.

49. The method of claim 35, wherein said heating is applied to the olefinic material non-uniformly with a temperature variation within the olefinic material of higher than 20 degree C. during heating.

50. The method of claim 49, wherein the gel content in the medical implant measured by solvent extraction is non-uniform and the gel content in the medical implant measured by boiling xylene varies between 65% and 100%.

51. The method of claim 35, wherein said cooling rate is 1 degree C. per minute or lower.

52. The method of claim 35, wherein said cooling step is achieved by quenching.

53. A method for producing a medical implant made from a powder olefinic material having a molecular weight of between 400,000 and 10,000,000, it comprises the steps of:
placing the powder olefinic material in the cavity of a compression mold;
removing air and moisture from the powder olefinic material;
compression molding the olefinic powder material into the near-finished or finished implant by simultaneously applying sufficient pressure and heat in an oxygen reduced atmosphere for a predetermined time at a temperature above the melting point of said powder olefinic material to generate free radicals and form cross-links in the polymer micro-structure; and
cooling the molded implant in an oxygen reduced atmosphere from said temperature to eliminate free radicals and form crosslinks in the polymer micro-structure.

54. The method of claim 53, wherein the powder olefinic material is resin powder of ultra high molecular weight polyethylene.

55. The method of claim 53, wherein said air and moisture is removed by flushing said powder olefinic material with an inert gas selected from the group consisting of nitrogen, helium, argon and a combination thereof, or by applying a vacuum of less than 2 inches of mercury to said powder olefinic material.

56. The method of claim 53, wherein said pressure is between 6.9 MPa (1000 psi) and 69 MPa (10,000 psi); said predetermined temperature is between 160 degree C. and 350 degree C and said predetermined time is between 5 seconds and 24 hours.

57. The method of claim 53, wherein said oxygen reduced atmosphere has no more than 2% oxygen.

58. The method of claim 57, wherein said oxygen reduced atmosphere is made up of an inert gas selected from the group consisting of nitrogen, helium, argon, and a combination thereof.

59. The method of claim 57, wherein said oxygen reduced atmosphere is a sensitizing environment made up of a gas selected from the group consisting of acetylene, ethylene, hydrogen, and a combination thereof.

60. The method of claim 59, wherein said sensitizing environment is made up of a gas mixture comprising 2% volume of acetylene and 98% volume of nitrogen.

61. The method of claim 57, wherein said oxygen reduced atmosphere is produced by a vacuum of less than 2 inches of mercury.

62. The method of claim 53, wherein the level of free radicals in said medical implant is less than 1.0.times.10.sup.15/gram and the medical implant has a non-increasing FTIR (Fourier Transform Infra-red Spectroscopy) oxidation index of less than 0.01 which does not increase with oven aging in air at 80 degree C. for up to 11 days.

63. The method of claim 54, wherein the medical implant has a gel content of higher than 65% measured by boiling xylene extraction.

64. The method of claim 53, wherein said heating is applied to the olefinic material uniformly with a temperature variation within the olefinic material of less than 20 degree C. during heating.

65. The method of claim 53, wherein said heating is applied to the olefinic material non-uniformly with a temperature variation within the olefinic material of higher than 20 degree C. during heating.

66. The method of claim 65, wherein the gel content in the medical implant measured by solvent extraction is non-uniform and the gel content in the medical implant measured by boiling xylene varies between 65% and 100%.

67. The method of claim 53, wherein said cooling rate is 1 degree C. per minute or lower.

68. The method of claim 53, wherein said cooling step is achieved by quenching.

69. The method of claim 53, wherein said near-finished or finished implant is a hip or knee implant.

70. A medical implant comprising a thermally crosslinked ultra-high molecular weight polyethylene having a weight average molecular weight greater than 400,000 and a gel content of higher than 65% measured by boiling xylene extraction.

71. A medical implant comprising a thermally crosslinked ultra-high molecular weight polyethylene having a weight average molecular weight greater than 400,000 and a free radical concentration of less than 1.0.times.10.sup.15/gram.

72. A medical implant comprising a thermally crosslinked ultra-high molecular weight polyethylene having a weight average molecular weight greater than 400,000 and a non-increasing FTIR (Fourier Transform Infra-red Spectroscopy) oxidation index of less than 0.01 which does not increase with oven aging in air at 80 degree C. for up to 11 days.

73. A medical implant comprising a thermally crosslinked ultra-high molecular weight polyethylene having a weight average molecular weight greater than 400,000 and a crystallinity close to or lower than the crystallinity of non-crosslinked ultra high molecular weight polyethylene.

74. A medical implant comprising a thermally crosslinked ultra-high molecular weight polyethylene having a weight average molecular weight greater than 400,000 and an ultimate tensile strength substantially equal to the ultimate tensile strength of non-crosslinked ultra high molecular weight polyethylene.

75. A medical implant comprising a thermally crosslinked ultra-high molecular weight polyethylene having a weight average molecular weight greater than 400,000 and an elongation at break close to or higher than the elongation at break of non-crosslinked ultra high molecular weight polyethylene.

76. A medical implant comprising a thermally crosslinked ultra-high molecular weight polyethylene having a weight average molecular weight greater than 400,000 and a tensile toughness close to or higher than the tensile toughness of non-crosslinked ultra high molecular weight polyethylene.
